(19) United States
(12) Patent Application Publication
(10) Pub. No.: US 2014/0279994 A1
(43) Pub. Date: Sep. 18, 2014

(54) TAGGING DIGITAL CONTENT WITH QUERIES

(71) Applicant: MICROSOFT CORPORATION, Redmond, WA (US)

(72) Inventors: Antonino Gulli, Pisa (IT); Maria I. Carrelli, London (GB)

(73) Assignee: MICROSOFT CORPORATION, Redmond, WA (US)

(21) Appl. No.: 13/826,542

(22) Filed: Mar. 14, 2013

(51) Int. Cl. G06F 17/30

(52) U.S. Cl. CPC G06F 17/30864
USPC 707/706; 707/722; 707/767

(57) ABSTRACT

Digital content can be annotated with a query. Upon selection of the query, a search can be initiated on a search engine with the query and search results relevant to the query are returned. Suggestions can be provided automatically in conjunction with query insertion. Suggestions can be supplied as a function of an input fragment and past search engine queries, among other things.

### BACKGROUND

Digital images are often tagged to facilitate organization and search. Tags are words or phrases meant to act as keywords that can be associated with an image. Tagging, or annotation, refers to the process of adding metadata to images by way of tags. Images can subsequently be organized into categories based on keywords specified by tags. Furthermore, since most search engines employ textual queries, tags provide a mechanism to make images searchable. In this case, a search engine seeks to match a query to keywords specified by image tags.

Tags can be global or regional. A global tag corresponds to all objects in an image. In other words, the global tag is specified with respect to the image as a whole. For example, an image can be tagged with the date the image was taken. A regional tag refers to one or more objects in a particular region of the image. Here, a mechanism can be provided to dynamically size a rectangular region over a portion of an image and insert a tag with respect thereto. For example, a user can select a region that includes a person and insert the name of a person within the region as a tag.

Automatic suggestion can be employed to aid tagging by suggesting a tag or completing a tag as input is specified character by character. Consider a social network service in which a user has identified a number of other social network service users as social connections. In this context, the name of a social connection can be suggested automatically based on an input prefix specified by a user. As a result, an image can be tagged with a social network user's name.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to tagging digital content with queries, or, in other words, query annotation. Digital content such as an image or a video, for example, can be annotated with one or more queries comprising one or more textual search terms. Moreover, such query annotation can be embodied as a hyperlink that targets a search engine with the query. Subsequently, upon selection of the query or associated region, a search is initiated on a search engine with the query. Relevant search results can be returned in response to the search, for example on a search engine results page (SERP). Additionally, search terms can be automatically suggested to facilitate query annotation. In accordance with one embodiment, search terms can be suggested as a function of past search-engine queries and an input query fragment. Entity-based systems, object-detection technology, and social network information can also be exploited in conjunction with suggestion. Furthermore, digital content can be annotated with a query automatically with little or no user intervention.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a query annotation system.

FIG. 2 illustrates annotation of an exemplary digital image.

FIG. 3 illustrates an exemplary interaction with an annotated image.

FIG. 4 is a block diagram of a representative suggestion component.

FIG. 5 is a flow chart diagram of a method of query annotation.

FIG. 6 is a flow chart diagram of a method of annotated content interaction.

FIG. 7 is a flow chart diagram of a method of suggesting search terms for query annotation.

FIG. 8 is a flow chart diagram of a method of suggesting search terms for query annotation.

FIG. 9 is a flow chart diagram of a method of automatic content annotation.

FIG. 10 is a schematic block diagram illustrating a suitable operating environment for aspects of the subject disclosure.

### DETAILED DESCRIPTION

Details below generally concern tagging digital content with queries, or, in other words, query annotation. Tags conventionally correspond to one or more textual keywords that can be employed by a search engine to identify content that satisfies subsequent queries. However, tags can also be queries themselves. Digital content such as a digital images or videos can be tagged, or, in other words, annotated with a query comprising one or more textual search terms. Furthermore, the query can be embodied as a hyperlink that targets a search engine with the query. Upon selection of a piece of content annotated with a query, a search can be initiated on a search engine with the query. Search results relevant to the query can then be returned by the search engine, for example on a search engine results page (SERP). Consequently, users can easily acquire additional information about a piece of digital content or portion thereof. Further, search terms making up a query can be automatically suggested to aid annotation. In one instance, query search terms can be suggested as a function of an input query fragment and past queries submitted to a search engine. Other information can also be utilized to improve suggestions including a rich structure afforded by an entity-based system and social network information, among other things. Furthermore, object detection technology can be exploited to provide suggestions from within a particular class of objects. Digital content can also be tagged automatically with little or no user intervention by again exploiting object detection technology, for example.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Referring initially to FIG. 1, a query annotation system 100 is illustrated. The query annotation system 100 can include or interact with content repository 110. The content repository 110 stores pieces of digital content comprising images, audio, and/or video, among other content, that is published, distributed, or otherwise available in a digital form. Annotation component 120 is configured to enable annotation, or, in other words, tagging, of pieces of content stored in the content repository 110. In addition to conventional keyword tags, the annotation component 120 can facilitate tagging content with queries. Stated differently, the annotation component 120 can enable content to be annotated with query tags. In accordance with one embodiment, the annotation component 120 can receive, retrieve, or otherwise obtain or acquire input text such as search terms and automatically generate a search query based thereon that can initiate a search on a search engine with the search terms. The search query can subsequently be saved as metadata with respect to a particular piece of digital content stored in the content repository 110. For example, the annotation component 120, upon receipt of a query comprising one or more search terms, can automatically generate a hyperlink search query as a tag for a piece of digital content such as an image. The hyperlink search query can include the query as display text and target a search engine with the query. Upon acquiring a signal indicative of selection of such a tag (e.g., clicking, gesture, voice command . . . ), a targeted search is initiated on search engine 130 with the query and search results are returned, for instance on a search engine report page (SERF). The search engine 130 can be any one of a number of web or other conventional search engines that locate information from a local or distributed data store (e.g., World Wide Web) relevant to a search query.

Suggestion component 140 is configured to facilitate specification of a search query. The suggestion component 140 can automatically suggest search terms based on an input query fragment. A query fragment is generally a part of a larger query. For instance, a query fragment can be one or more search terms or a portion thereof (e.g., one or more characters). As a user inputs a search term character by character, for example, the suggestion component 140 can make suggestions that complete the search term. Further, the suggestion component 140 can also recommend one or more additional search terms, namely prefix and or suffix search terms. In accordance with one embodiment, the source of suggestions can be the search engine 130 or more particularly past queries submitted to and recorded by the search engine 130. In this case, a large number of past queries submitted by numerous users can be exploited for purposes of tagging digital content.

FIG. 2 illustrates annotation of an exemplary digital image 210 of a man wearing a black hat. The annotation component 120 provides a mechanism to allow specification and receipt of search terms for a query with respect to the image 210, and the suggestion component 140 is configured to suggest or recommend search queries comprising one or more search terms. In this instance, annotation is regional rather than global. In other words, the tag or annotation pertains to a specific region in the image rather than the image as a whole. The annotation component 120 can enable a user to dynamically size and position a rectangle or other shape over a portion of an image. Here, a rectangle surrounds the hat on the man's head. Further, the annotation component 120 allows textual input of search terms. In this case, “BLACK H” 220 is specified. In response to the input, suggestion component 140 can suggest or recommend “BLACK HAT” 230, based the input and past search engine queries, for example. Of course, other suggestions are also possible based on “H” as a query fragment, such as “RED HAT” and “BLACK HAIR.” A user can accept the recommendation “BLACK HAT” 230 or continue character-by-character input. Once a user is finished specifying search terms, a query tag can be generated and utilized to annotate the image 210. For example, information regarding the region can be saved in conjunction with a hyperlink including the search terms as image metadata. More specifically, the query “BLACK HAT” can be transformed into a hyperlink search query that includes display text that specifies the query “BLACK HAT” and a link that passes the search query to a search engine such as, “http://www.bing.com/search?q=BLACK+HAT.” The query tag thus provides a bridge between an otherwise passive image and a search engine.

FIG. 3 illustrates exemplary interaction with an annotated image. The annotated image 310 comprises a search query tag associated with the black hat on top of the man's head. The annotated image 310 can be produced as previously described in conjunction with FIG. 2. In one implementation, a rectangle can be displayed over the image to indicate the presence of a query tag, for instance upon cursor rollover. Additionally or alternatively, the query “BLACK HAT” can be displayed to the user. Upon receipt of a signal indicative of selection of the query tag, or the region surrounding, or otherwise associated with, the query tag, a search is initiated on the search engine 130. In other words, a link to a search engine that passes the query is followed. The signal can correspond to positioning cursor 312 over the hat and clicking as shown. Other selection signals are also possible including, but not limited to, a single- or multi-touch gesture with respect to the hat on a touch screen display and voice commands. The search engine 130 can execute a search for information relevant to the search query provided. Here, the search query is “BLACK HAT.” A search engine results page (SERP) 320 can be output by the search engine 130. In this case, the query search box 322 includes “BLACK HAT” indicating that a search was performed for “BLACK HAT.” Additional information can be provided including links to webpages concerning black hats and/or images of black hats, among other things.

Although FIGS. 2 and 3 describe annotation with respect to a static image, the claimed subject matter is not limited thereto. By way of example, disclosed aspects are also applicable to digital video and multimedia content. For instance, a television show or television advertisement can be annotated with a query hyperlink. Here, however, object recognition or other technology can be employed to enable a tag to be maintained across a sequence or stream of content. Suppose, for instance, that the man in the hat is actually part of a television commercial. Once the hat is annotated, the annotation should remain regardless of the movement of the man as well as across scene switches in which he is present, not present, and then present again.

Turning attention to FIG. 4, a representative suggestion component 140 is provided in further detail. The suggestion component 140 can interact with one or more data stores 400 as a source of suggestions. Search component 410 is configured to provide suggestions based on past queries as previously described. Accordingly, the one or more data stores 400 can record past queries previously issued to a search engine. The search component 410 can expose search terms of the past queries as suggestions for digital content annotation.

Entity component 420 is configured to provide entity-based suggestion for digital content annotation. The one or more data stores 400 can include one or more entity databases comprising a plurality of entities and relationships between entities. An entity in the context of an entity-based system corresponds to a person, place, or thing. Systems known in the art are able to identify entities from web documents, for example, and map relationships between entities. In other words, a rich structure of relationships can be captured by an entity database. By way of example, a person can be identified as an actor and the films the actor stared in can be connected to the actor as well as other information such as birthday, religion, and relatives, among other things. This rich structure of entities and relationships between entities can be exploited to facilitate digital content annotation. For instance, the entity component 420 can identify an entity associated with a search term and suggest other related entities. This can provide a richer experience than employing previous queries. However, both past search queries and related entities can be utilized together. For instance, entity relationships can be utilized to disambiguate a query. More concretely, from an entity relationship it can be determined that “Jaguar” is both an animal and a car. Accordingly, the entity component 420 can suggest animal and car as potential additional search terms to locate relevant information. A user can then select the appropriate term to disambiguate the meaning. This term associated can then be added or otherwise associated with a query tag. Consequently, when a query is subsequently initiated on a search engine by selecting the query tag, appropriate disambiguated results are returned.

Class component 430 is configured to identify an object class and make suggestions related to a class of objects. For example, computer-vision object detection technology can be employed to enable objects to be detected in an image or other piece of visual content. Further, a determination can be made as to what class or category the object belongs. For instance, the object could be a face or a car. Based on the class, suggestions associated with query tags can be made from the same or like class. Further, the class component 430 can be employed in combination with other suggestion mechanisms. For example, the class component 430 could be employed as a filter over past queries.

Social network component 440 is configured to provide suggestions based on user social information from a social network service. Social information can include a user's social connections and profile information, among other information that can be acquired from a social network service. The information can be captured in a social network graph in one or more of the data stores 400. Such social network information can be utilized to guide query suggestions. For example, query suggestions can be generated or filtered as a function of a user's social network service connections or all social network service users. More specifically, if a social network connection expresses interest in content either explicitly (e.g., content is liked) or implicitly (e.g., sharing content) such information can be utilized to make suggestions since a user's social network service connections are likely to include similar interests.

In addition to use of entity relationship information to suggest query search terms, entities and entity relationships can be injected automatically into search queries to provide context and enable more relevant search results to be returned. More particularly, related entities can be injected has hidden context. By hidden it is meant that such information may not be displayed as part of a query tag. For example, the context can be injected in the query passed to a search engine by way of a hyperlink but absent from hyperlink display text. Of course, this information need not be hidden and can be exposed in a number of different ways. For instance, upon placing a cursor on a query tag and hovering over the tag for a predetermined time such information can be displayed as a type of tooltip or hint.

Object detection technology can also be employed outside automatic suggestions. In one embodiment, the annotation component 120 can be configured to annotate pieces of content with queries automatically with little or no user involvement. Object detection technology can be utilized in this instance to identify objects and one or more classes to which they belong. The annotation component 120 can then insert a query including search terms that comprise a class name and/or any other information that can be ascertained for instance by comparing objects to other objects and their tags. For example, if from an image an object is identified which is a car, it can be annotated to include car as part of a query tag. Further, the object can be compared to other previously tagged images or portions thereof to determine if additional or more specific query tags are can be inserted. For instance, if based on image comparison it can be determined within a predetermined level of confidence that the car is of a particular brand (e.g., Ford®, Lexus® . . . ) or style (e.g., sedan, hatchback, hybrid . . . ) that information can be employed in conjunction with automatic annotation. In another instance, object detection technology can be employed determine and automatically annotate content with location. By way of example, an image can be annotated with the location where the image was taken, and this location can be transformed into a rich query structure for retrieving relevant search results when a search is initiated.

Annotated digital content can also be employed to improve search and annotation. Selecting or not selecting a query tag can express interest or a lack of interest in digital content including the tag. By selecting a query tag that initiates a search, the user selecting the query tag can be deemed to be expressing interest or approval of the digital content. In this case, such interest or approval can be recorded with respect to the user, if allowed by privacy settings. Subsequently, any searches, search suggestions, or annotations can employ this information to provide relevant information to particular users. Additionally or alternatively, searches can be biased as a function of this information by injecting this information into search queries as a type of context information.

Furthermore, it should be appreciated that annotated digital content can be exploited to provide relevant advertisements in conjunction with the presentation of the content. Query tags comprising one or more search terms as well as other metadata can be provided to an advertisement service. Subsequently, advertisements relevant to the provided search terms can be served and presented with the content.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the suggestion component 140 can employ such mechanism to assist in identifying relevant suggestions or recommendations of search query terms.

In view of the exemplary systems described above, methodologies that may be implemented in accordance with the disclosed subject matter will be better appreciated with reference to the flow charts of FIGS. 5-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method of query annotation 500 is illustrated. At reference numeral 510, input text, comprising one or more textual search terms for instance, is received, retrieved, or otherwise obtained or acquired. For example, the input text can be one or more search terms input by a user. Alternatively, the input text can correspond to one or more conventional keyword tags. At numeral 520, a query is generated from one or more textual search terms. For instance, a link can be generated that initiates a search on a search engine with at least the one or more textual search terms. At reference 530, a piece of digital content, such as an image, that was the target of the one or more search terms is annotated with the query. Stated differently, the content is tagged with a query capable of initiating a search with specified search terms.

FIG. 6 depicts a method of annotated content interaction 600. At reference numeral 610, a signal indicative of selection of content annotated with a query is received or otherwise acquired. The signal can vary and may depend on capabilities of a particular computing device. As non-limiting examples, the signal can correspond to any gesture performed on a touch screen or touchpad (e.g., single or multi-touch gesture) or with a cursor controlled by a mouse (e.g., point and click) or other input device. In addition, the signal can correspond to a voice command captured by a microphone or a body motion gesture captured by a camera. At numeral, 620, a search is initiated on a search engine with the query comprising one or more search terms. At reference numeral 630, query results are received from the search engine. The results could correspond to a search engine results page (SERP). However, results could also be received in other forms and/or integrated within a system, for example.

FIG. 7 depicts a method of suggesting search terms for query annotation 700. At numeral 710, textual search terms are received or otherwise acquired in conjunction with content annotation or tagging. At reference 720, one or more related search terms are identified as a function of at least one or more received search terms or a portion thereof. At reference numeral 730, the one or more related search terms are suggested or recommended. For example, if the received input is “Black H,” “Hat” or “Hair” may be suggested to complete the query fragment “H.” In other words, the suggestions would be “Black Hat” and “Black Hair,” respectively.

FIG. 8 illustrates a method of suggesting search terms for a query annotation 800. At reference numeral 810, an object is identified in a piece of digital content. At numeral 820, a class to which the object belongs is determined. In the context of a digital image, for instance, an object can be identified and classified utilizing known computer-vision object detection technology. For example, an object can be identified and classified as a face or a car. At numeral 830, a search term is suggested as a function of the class determined for the object. For example, if the object is classified as a car, suggested search terms can pertain to cars, such as car brands, models, parts, and accessories. Of course, the class can also be suggested, such as car in the previous example. In accordance with one embodiment, the source of search term suggestions can be past queries recorded and made available by a search engine. In this instance, suggestion can an involve filtering search terms based on class.

FIG. 9 is a flow chart diagram of a method of automatic content annotation 900. At reference numeral 910, a piece of digital content such as an image or video or a portion thereof is identified. At numeral 920, a relevant query comprising one or more search terms is determined for the identified piece of digital content or portion thereof. Such a determination can involve utilizing automatic image or video analysis techniques known in the art to identify and classify objects. Once an object is identified and classified, one or more search terms comprising a query can be identified as a function of the class or category of the object. Stated differently, search terms descriptive of the object can be selected from a source of search terms. At numeral 930, the piece of digital content or portion thereof can be annotated with the query comprising one or more keywords. Annotation can comprise adding a hyperlink search comprising the query to digital content metadata.

Suggestions provided herein can exploit automatic suggestion functionality employed by a search engine by interacting with a suggestion server of the search engine, for example. In one instance, suggestions can include not only query suggestions but also uniform resource identifiers (URIs) for web resources, such as web pages, prior to search execution based on a user's search history, others' search history, and/or popularity, among other things. In this case, such suggestions can be made available with respect to tagging digital content as described herein. For example, a user can tag content or a portion thereof with a particular webpage suggested. More specifically, rather than tagging content with a hyperlink that targets a search engine with a query, the hyperlink can target a particular web page.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” “system,” and “engine” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’” employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer 1010 or computing device (e.g., desktop, laptop, tablet, server, hand-held, programmable consumer or industrial electronics, set-top box, game system, compute node . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store the desired information and accessed by the computer 1010. Furthermore, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the query annotation system 100, or portions thereof, can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the query annotation system 100 and/or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, LED, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
creating a hyperlink search query automatically in response to text input; and
annotating a piece of digital content with the query.

2. The method of claim 1 further comprises suggesting a search term as the text input for the query as a function of past search-engine queries and an input query fragment.

3. The method of claim 2 further comprises:
identifying an entity from the query;
extracting one or more related entities from a knowledge repository; and
suggesting the search term as a function of the one or more related entities.

4. The method of claim 2 further comprises automatically detecting an object in the piece of digital content and suggesting the search term based on a class of object detected.

5. The method of claim 2 further comprises suggesting the search term as a function of social network service information.

6. The method of claim 1 further comprises:
identifying an entity from the query;
extracting one or more related entities from a knowledge repository; and
adding one or more of the one or more related entities to the query.

7. The method of claim 6 further comprises displaying the one or more related entities with the query with respect to the piece of digital content.

8. The method of claim 1 further comprises:
detecting an object automatically in the piece of digital content; and
providing the identity of the detected object as the text input.

9. The method of claim 1 further comprises recording information about a user that selects the query and initiates a search.

10. The method of claim 1, further comprises initiating a search on a search engine with the query in response to a signal indicative of selection of the query.

11. A system, comprising:
a processor coupled to a memory, the processor configured to execute the following computer-executable components stored in the memory:
a first component configured to accept a search query comprising one or more search terms as a digital content tag; and
a second component configured to suggest a search term based on an input query fragment.

12. The system of claim 11 further comprises a third component configured to suggest a search term as a function of past search-engine queries.

13. The system of claim 11 further comprises a third component configured to identify an entity based on the input query fragment and suggest a search term as a function of related entities.

14. The system of claim 11 further comprises a third component configured to identify an object of the tag, determine a class of objects to which the identified object belongs, and suggest a search term that belongs to the class.

15. The system of claim 11 further comprises a third component configured to suggest a search term based on social network service information.

16. The system of claim 11 further comprises a third component configured to generate a hyperlink that targets a search engine with the query.

17. A computer-readable storage medium having instructions stored thereon that enable at least one processor to perform a method upon execution of the instructions, the method comprising:
receiving a signal indicative of selection of a digital content tag; and
initiating a search on a search engine with a query comprising the tag in response to the signal.

18. The method of claim 17 further comprises initiating the search with the query as a function of identification of one or more entities included in the query and one or more related entities acquired from an entity-based system.

19. The method of claim 17 further comprises initiating the search with the query as a function of social network information regarding a user providing the signal.

20. The method of claim 17 further comprises receiving search results from the search engine in response to the query.
